(19) United States
(12) Patent Application Publication
(10) Pub. No.: US 2024/0286566 A1
(43) Pub. Date: Aug. 29, 2024

(54) VEHICLE SYSTEMS AND METHODS FOR POWER MANAGED RESOURCE ACTIVATION

(71) Applicant: GM GLOBAL TECHNOLOGY OPERATIONS LLC, Detroit, MI (US)

(72) Inventors: Yiran Hu, Shelby Twp., MI (US); Jorge R. Flores, Macomb, MI (US); Abdelhalim Ragab, Canton, MI (US); Frank Ghenassia, Ramat Gan, MI (US)

(73) Assignee: GM GLOBAL TECHNOLOGY OPERATIONS LLC, Detroit, MI (US)

(21) Appl. No.: 18/173,389

(22) Filed: Feb. 23, 2023

(51) Int. Cl. B60R 16/033; G06F 8/65

(52) U.S. Cl. CPC B60R 16/033; G06F 8/65

(57) ABSTRACT

Vehicles and related systems and methods are provided for managing energy consumption by resources associated with the vehicle. A power management service receives an abstract request for a resource from a software entity, obtains current status information for the vehicle from one or more systems associated with the vehicle, determines whether the requested activation of the resource associated with the abstract resource abstract request is permitted based at least in part on the current status information and a usage profile associated with the abstract resource request, and in response to determining the requested activation of the resource is permitted, the power management service automatically provides a concrete activation request to the resource.

### INTRODUCTION

The technical field generally relates to vehicle systems and more particularly relates to managing power consumption and resource utilization by software applications.

Modern vehicles often utilize software platforms and corresponding electrical architectures that enable various features and functions of the vehicle using software that functions as an interface between the driver or other user and the underlying vehicle hardware. The software supports various features and functionality of the vehicle, while also allowing features and/or functionality associated the vehicle to be added and/or updated to improve user experience by updating software without changing the underlying hardware, thereby allowing the vehicle to evolve over time. One goal of a so-called software defined vehicle (SDV) is typically to provide flexibility and extensibility when deploying software applications by abstracting underlying hardware implementations, such that software applications can be designed and developed independent of the vehicle (e.g., by third-party application developers). However, this may result in unpredictable power requirements that cannot be fully defined at design time. Accordingly, it is desirable to provide systems and methods for supporting dynamic and unpredictable power requirements by different potential software applications that may be deployed to a vehicle. Other desirable features and characteristics of the present invention will become apparent from the subsequent detailed description and the appended claims, taken in conjunction with the accompanying drawings and the foregoing introduction.

### SUMMARY

Apparatus for a vehicle and related methods for managing energy consumption are provided. One method involves obtaining, at a power management service executing on a computing device onboard the vehicle, an abstract request for activation of a resource associated with the vehicle from a software entity, the abstract request including a usage profile associated with a requested activation of the resource, obtaining, by the power management service, current status information for the vehicle from one or more systems associated with the vehicle, determining, by the power management service, the requested activation of the resource is permitted based at least in part on the current status information and the usage profile associated with the abstract request, and in response to determining the requested activation of the resource is permitted, automatically providing, by the power management service, a concrete activation request to the resource.

In one aspect, the method involves the power management service translating the abstract request from an abstract form into the concrete activation request by identifying a destination associated with the resource associated with the abstract request and an appropriate format for the concrete activation request prior to providing the concrete activation request in the appropriate format to the destination associated with the resource. In another aspect, the method involves the power management service mapping an abstract identification of the resource associated with the abstract request to a concrete address associated with the resource prior to providing the concrete activation request to the concrete address.

In another aspect, obtaining the current status information involves obtaining a current energy state of an electrical system of the vehicle from a control module associated with the electrical system and determining the requested activation of the resource is permitted involves verifying the current energy state of the electrical system satisfies one or more activation criteria for the resource. In a further aspect, the power management service instructs the control module associated with the electrical system to modify a state of the electrical system to support the requested activation of the resource after determining the current energy state of the electrical system does not satisfy the one or more activation criteria. In another aspect, instructing the control module associated with the electrical system to modify the current energy state involves the power management service instructing the control module to modify the state of a high voltage battery associated with the electrical system prior to providing the concrete activation request to the resource.

In another aspect, obtaining the current status information includes obtaining a current vehicle mode from a control module associated with the vehicle, and determining the requested activation of the resource is permitted includes verifying the requested activation of the resource is permitted in the current vehicle mode. In another aspect, the power management service updates an activation state associated with the resource maintained in a data storage element associated with the computing device after providing the concrete activation request to the resource. In another aspect, the power management service publishes an updated activation state associated with the resource to the software entity after providing the concrete activation request to the resource. In yet another aspect, the automatically providing the concrete activation request to the resource involves periodically providing the concrete activation request to the resource in accordance with the usage profile when the usage profile comprises a periodic usage profile. In another aspect, automatically providing the concrete activation request to the resource involves the power management service maintaining the requested activation of the resource in accordance with the usage profile until determining the requested activation of the resource should be terminated.

An apparatus is provided for a non-transitory computer-readable medium having stored thereon executable instructions that, when executed by a processor, cause the processor to provide a power management service configurable to receive an abstract request for activation of a resource associated with a vehicle from a software entity, the abstract request including a usage profile associated with a requested activation of the resource, obtain, from one or more systems onboard the vehicle, current status information for the vehicle, determine the requested activation of the resource associated with the abstract request is permitted based at least in part on the current status information and the usage profile associated with the abstract request, and in response to determining the requested activation of the resource is permitted, automatically provide a concrete activation request to the resource. In one aspect, the power management service is configurable to translate the abstract request from an abstract form into the concrete activation request prior to providing the concrete activation request to the resource. In another aspect, the power management service is configurable to map an abstract identification of the resource associated with the abstract request to a concrete address associated with the resource prior to providing the concrete activation request to the concrete address. In another aspect, the power management service is configurable to obtain a current energy state of an electrical system of the vehicle from a control module associated with the electrical system and verify the current energy state of the electrical system satisfies one or more activation criteria for the resource before determining the requested activation of the resource is permitted. In a further aspect, the power management service is configurable to instruct the control module associated with the electrical system to modify a state of a high voltage battery associated with the electrical system to support the requested activation of the resource after determining the current energy state of the electrical system does not satisfy the one or more activation criteria prior to providing the concrete activation request to the resource. In another aspect, the power management service is configurable to obtain a current vehicle mode from a control module associated with the vehicle and verifying the requested activation of the resource is permitted in the current vehicle mode prior to determining the requested activation of the resource is permitted.

An apparatus is also provided for a vehicle that includes an electrical system to operate a resource associated with the vehicle, wherein the resource is coupled to the electrical system, and a computing device coupled to the electrical system and the resource. The computing device includes a non-transitory computer-readable medium having executable instructions stored thereon and a processor coupled to the non-transitory computer-readable medium to execute the executable instructions to provide a power management service that is configurable to receive an abstract request for the resource associated with the vehicle from a software entity, the abstract request having a usage profile for a requested activation of the resource associated therewith, obtain a current energy state of the electrical system from a control module associated with the electrical system, determine the requested activation of the resource associated with the abstract request is permitted based at least in part on the current energy state and the usage profile associated with the abstract request, and in response to determining the requested activation of the resource is permitted, automatically provide a concrete activation request to the resource. In one aspect, the software entity comprises a software application or a software service configurable to provide the abstract request in an abstract form, wherein the power management service is configurable to translate the abstract request from the abstract form to a concrete form before providing the concrete activation request to the resource. In another aspect, the power management service is configurable to map an abstract identification of the resource associated with the abstract request to a concrete address associated with the resource prior to providing the concrete activation request to the concrete address.

### BRIEF DESCRIPTION OF THE DRAWINGS

The exemplary aspects will hereinafter be described in conjunction with the following drawing figures, wherein like numerals denote like elements, and wherein:

FIG. 1 is a block diagram illustrating a vehicle in accordance with various implementations; and

FIG. 2 depicts a flow diagram of a resource activation process suitable for implementation by a power management service in connection with a vehicle according to one or more implementations described herein.

### DETAILED DESCRIPTION

The following detailed description is merely exemplary in nature and is not intended to limit the application and uses. Furthermore, there is no intention to be bound by any expressed or implied theory presented in the preceding introduction, summary, or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

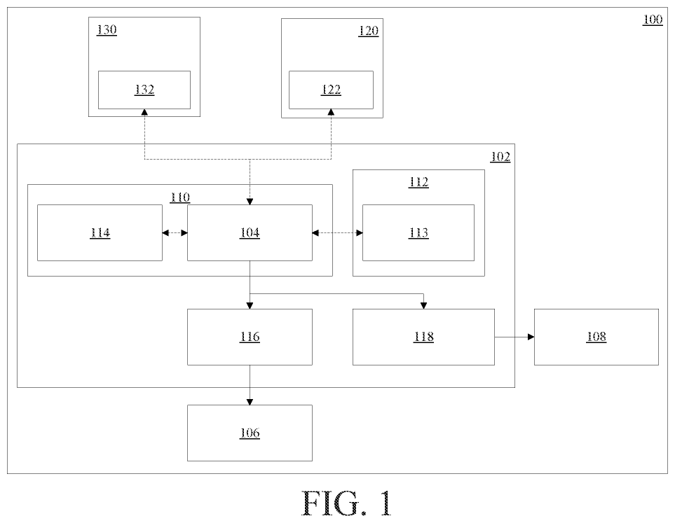

FIG. 1 depicts an exemplary vehicle 100 including a computing device 102 that supports a power management service 104 configurable to manage power consumption and utilization of different resources 106, 108 onboard the vehicle 100. For purposes of explanation, the subject matter may be described herein in the context of the vehicle 100 being realized as an automotive vehicle, such as a passenger car, a sport utility vehicles (SUV), a pickup truck, or the like, but it should be appreciated that the subject matter described herein is not limited to automotive vehicles, and can be implemented in an equivalent manner in the context of any other vehicle including motorcycles, trucks, recreational vehicles (RVs), marine vessels, aircraft, and the like.

The computing device 102 generally represents an electronic component onboard the vehicle 100 that includes at least one processor 110 and data storage element 112. In this regard, the computing device 102 may be realized as a system on a chip, integrated circuit or another electronics module. The processor 110 can include or be realized as any custom made or commercially available processor, a central processing unit (CPU), a graphics processing unit (GPU), an auxiliary processor among several processors associated with the computing device 102, a semiconductor-based microprocessor (in the form of a microchip or chip set), a macroprocessor, any combination thereof, or generally any device for executing instructions. The data storage element 112 includes or is otherwise realized as a non-transitory computer readable storage device or media, which may include volatile and nonvolatile storage in read-only memory (ROM), random-access memory (RAM), and keep-alive memory (KAM), for example. KAM is a persistent or non-volatile memory that may be used to store various operating variables while the processor 110 is powered down. The data storage element 112 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the processor 110. The instructions may include one or more separate programs, each of which comprises an ordered listing of executable instructions for implementing logical functions. The instructions, when executed by the processor 110, cause the processor 110 to support or otherwise provide the power management service 104 and perform logic, calculations, methods and/or algorithms for supporting the subject matter described herein.

In the illustrated implementation, the data storage element 112 also includes executable instructions that are executed by the processor 110 to provide one or more software entities 114 supported by the computing device 102. In this regard, a software entity 114 generally represents a software application, service, or process designed to support one or more features or functions associated with the vehicle 100 using one or more resources 106, 108 onboard the vehicle 100. For example, the software entity 114 could be configured to navigation, route planning, vehicle controls, infotainment, autonomous driving and/or any other sort of features or functionality associated with the vehicle 100 capable of being managed or controlled via software. In this regard, the software entity 114 may be configurable to provide one or more graphical user interfaces (GUIs) capable of being utilized by a driver or other user to interact with the vehicle 100 and/or the resources 106, 108 associated therewith. It should be noted that although FIG. 1 depicts the software entity 114 as being implemented at the computing device 102, in practice, the software entity 114 may be implemented at another computing device or electronic device external to the computing device 102 that communicates with the computing device 102 over a wired and/or wireless communications network, such as, for example, another electronics module or component onboard the vehicle 100, a mobile device or other client electronic device associated with the driver or another passenger, and/or the like.

Still referring to FIG. 1, the different resources 106, 108 onboard the vehicle 100 generally represent different hardware components or systems associated with the vehicle 100 that are coupled to the vehicle electrical system 120 to receive electrical power that supports operation of the resources 106, 108, such as, for example, sensors, actuators, motors, transmission systems, pneumatic systems, hydraulic systems, displays, and/or the like. For example, in one or more implementations, the vehicle electrical system 120 includes one or more batteries or other energy storage elements capable of supplying electric power in a suitable voltage to support an electrical grid to operate one or more resources 106, 108 that are connected or otherwise coupled to the electrical grid. Some implementations of the vehicle electrical system 120 include a 12 Volt battery, which may alternatively be referred to as a low voltage battery, that supplies electrical power to the electrical grid, which may alternatively be referred to as a 12 V grid or a low voltage grid. Additionally, the vehicle electrical system 120 may include various switching elements, direct current to direct current (DC-DC) converters or other hardware or circuitry that support electrical power flow between the low voltage grid and one or more high voltage batteries that supplies electric power in a suitable voltage range (e.g., 350-800 Volts) to primarily provide power to a propulsion system associated with the vehicle 100.

Depending on the implementation, the computing device 102 may be associated with one or more resources 106 that are directly controlled by the processor 110, alternatively referred to herein as local resources, that are communicatively coupled to the computing device 102 via an input/output (I/O) interface 116 associated with the computing device 102, where the input/output interface 116 generally represents the firmware, middleware and/or hardware components that are configured to support communications between the processor 110 and the local resources 106. For example, in one implementation, the computing device 102 is realized as a vehicle cockpit unit (VCU), where the local resources 106 include one or more electronic displays or other infotainment modules associated with the VCU. Similarly, the computing device 102 may be communicatively coupled to one or more other resources 108 that are indirectly controlled by the processor 110, alternatively referred to herein as remote resources, that are communicatively coupled to the computing device 102 via a communications interface 118 that generally represents the firmware, middleware and/or hardware components that are configured to support communications between the processor 110 and a processor or controller associated with the remote resources 108 over a communications network, such as, for example, an Ethernet network, a local area network (LAN), a controller area network (CAN) or another wired network, a wireless network, and/or the like.

As described in greater detail below, during operation of the vehicle 100, the power management service 104 receives requests to activate or otherwise utilize one or more of the vehicle resources 106, 108 from the software entity 114, where the power management service 104 controls, regulates or otherwise manages activation of the requested vehicle resources 106, 108 depending on the current state of the vehicle 100. In this regard, the power management service 104 is coupled to one or more systems 120, 130 onboard the vehicle 100 to receive or otherwise obtain current status information indicative of a current state of the vehicle 100. For example, the power management service 104 may be coupled to a battery control module (BCM) 122 or other controller associated with the vehicle electrical system 120 to obtain information indicative of a current state of the vehicle electrical system 120. Additionally, or alternatively, the power management service 104 is coupled to an engine control unit (ECU) 132 or other controller associated with the vehicle control system 130 to obtain information indicative of a current mode or operating state of the vehicle 100. Based on the current status information obtained from the onboard systems 120, 130, the power management service 104 automatically determines whether or not activation of a requested resource 106, 108 is permitted, and when permitted, provides corresponding activation requests to the requested resource(s) 106, 108 to enable activation of the requested resource(s) 106, 108. In this manner, the power management service 104 functions as an intermediary that controls, regulates or otherwise manages energy consumption by the vehicle resources 106, 108 independent of the software entities 114.

As described in greater detail below, the power management service 104 interacts with software entities 114 to manage power usage by using power usage profiles provided by the software entities 114 in connection with resource activation requests. For example, a software entity 114 may provide a resource activation request that identifies one or more of the resources 106, 108 that the software entity 114 would like to be activated along with a power usage profile that identifies the amount or frequency of the expected utilization of the requested resource(s) 106, 108 and corresponding energy (or power) consumption, such as, for example, an expected duration or period of time that the software entity 114 would like the respective resource 106, 108 to be activated, a desired periodicity or frequency at which the software entity 114 would like the respective resource 106, 108 to be activated, an energy usage priority associated with reliance of the software entity 114 on the respective resource 106, 108, a dependency associated with the respective resource 106, 108, and/or the like. The software entity 114 may also provide, to the power management service 104, information identifying the relative priority of the requested resource 106, 108 or the dependency of the software entity 114 on the requested resource 106, 108 (e.g., to support functionality of the software entity 114), permissions associated with the software entity 114 accessing the requested resource 106, 108, and/or the like. In other implementations, the power usage profiles associated with particular resource activation requests from a respective software entity 114 may be stored or otherwise maintained in the local data storage element 112 (or downloaded from a remote server or system over a communications network) for retrieval or lookup by the power management service 104 in response to receiving a particular resource activation request from the respective software entity 114.

Based on the requested resource 106, 108, the requested power usage profile, and the current state of the vehicle 100, the power management service 104 determines whether or not the requested power usage of the requested resources 106, 108 is permitted and is capable of being supported by the vehicle 100, and if so, the power management service 104 commands, signals or otherwise instructs the requested resource(s) 106, 108 and potentially one or more onboard systems 120, 130 to support the requested power usage profile. In this regard, the power management service 104 abstracts activation of the resources 106, 108, such that the software entities 114 can request a particular resource 106, 108 in an abstract format (e.g., by identifying a particular device, component, system, subsystem, service, or the like) and allow the power management service 104 to translate the abstract resource activation request from an abstract form into a physical, tangible or concrete form. For example, the power management service 104 may translate an abstract resource activation request by mapping the abstract identification of the requested resource to a particular hardware resource and identifying the corresponding physical address, network address, hardware address or other concrete address to be used as the destination for the activation request along with the corresponding activation messages, commands, instructions or other signals to be transmitted or otherwise provided to that concrete address to activate the resource. Thus, software entities 114 may be designed, developed or otherwise configured to request resources in a manner that is independent of the underlying physical configuration of the resources 106, 108 or platform associated with a respective vehicle 100, thereby providing interoperability of the software entities 114 across different vehicle platforms and/or different configurations of resources 106, 108 by abstracting the underlying physical activation implementation details to the intermediary power management service 104.

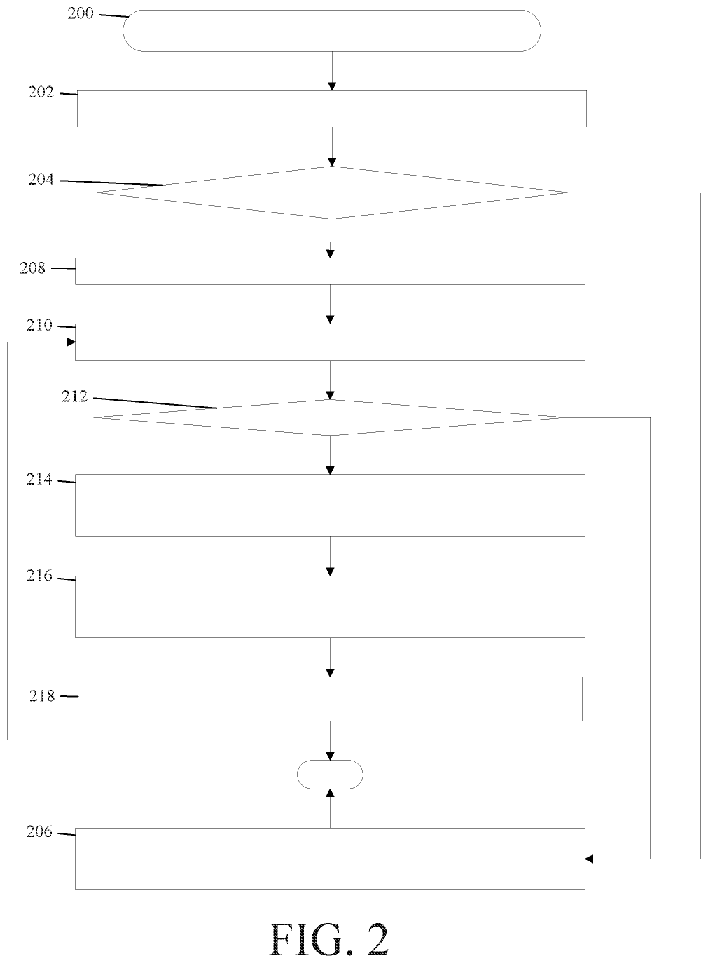

FIG. 2 depicts an exemplary implementation of a resource activation process 200 suitable for implementation by a power management service to manage utilization of vehicle resources by software entities and perform additional tasks, functions, and/or operations described herein. For illustrative purposes, the following description may refer to elements mentioned above in connection with FIG. 1. While portions of the resource activation process 200 may be performed by different elements of a vehicle system, for purposes of explanation, the subject matter may be primarily described herein in the context of the resource activation process 200 being primarily performed by the power management service 104 at a computing device 102 onboard the vehicle 100.

Referring to FIG. 2, with continued reference to FIG. 1, in exemplary implementations, the resource activation process 200 initializes or otherwise begins by receiving or otherwise obtaining an abstract request for utilization of one or more resources associated with a vehicle from a software entity at 202. As described above in the context of FIG. 1, a software entity 114 may communicate, transmit or otherwise provide a resource activation request to the power management service 104 that identifies one or more resources 106, 108 onboard the vehicle 100 that the software entity 114 would like to activate and utilize in an abstract form. For example, in an implementation where the software entity 114 is realized as a software application that supports navigation or other route planning features, in response to a user interacting with the software application to review or define a route, the software entity 114 may provide an abstract resource activation request to the power management service 104 that identifies on onboard global positioning system (GPS) receiver and an onboard display device (e.g., an electronic dashboard display) as the resources 106, 108 that the software entity 114 would like to activate to support the feature(s) that the user is attempting to access.

At 204, the resource activation process 200 continues by identifying or otherwise determining whether activation of the requested resource(s) is required at 204. In this regard, when a requested resource is already activated, the resource activation process 200 responds to the resource request by providing a notification to the requesting software entity at 206. As described in greater detail below, in exemplary implementations, after activating or deactivating a particular resource 106, 108, the power management service 104 automatically updates the current resource activation state information 113 to reflect the current activation state of the available resources 106, 108 capable of being managed by the power management service 104. In response to receiving a resource activation request, the power management service 104 queries or otherwise accesses current resource activation state information 113 that is cached or otherwise maintained by the data storage element 112. When the current resource activation state information 113 indicates a requested resource is currently active, the power management service 104 automatically responds to the resource request by providing notification to the requesting software entity 114 that the requested resource 106, 108 is active, thereby allowing the software entity 114 to proceed with utilization of the requested resource 106, 108.

When activation of a requested resource is required, the resource activation process 200 continues by receiving or otherwise obtaining a power usage profile associated with the resource request at 208. The resource activation process 200 identifies or otherwise obtains information indicative of the current state of the vehicle at 210 and then analyzes the power usage profile in relation to the current vehicle state to determine whether the power usage associated with the resource request is permitted at 212. When activation of the requested resource is not permitted given the current vehicle state, the resource activation process 200 provides a corresponding notification to the requesting software entity (e.g., at 206). In some implementations, in connection with providing a resource request, the requesting software entity 114 also provides a power usage profile that corresponds to the expected utilization of the requested resource(s). In this regard, the power usage profile indicates or is otherwise correlative to the expected power or energy consumption associated with the software entity 114 utilizing the requested resource(s) 106, 108 and may include, for example, an expected duration or period of time for which the software entity 114 intends to utilize the requested resource(s) 106, 108, the period or frequency at which the software entity 114 intends to utilize the requested resource(s) 106, 108, and/or the like. In other implementations, the power management service 104 may utilize a lookup table maintained in the data storage element 112 or at a remote system to identify a corresponding power usage profile to be associated with a particular resource request from a particular software entity 114. For example, an instance of the software entity 114 (or a developer associated with the software entity 114) may register one or more power usage profiles upon deployment of the software entity 114 to a particular vehicle 100.

After identifying a power usage profile for the resource request, the power management service 104 identifies or otherwise obtains information indicative of a current state of the vehicle 100 from one or more onboard systems 120, 130. For example, the power management service 104 may retrieve, from a BCM 122 or other control module associated with the vehicle electrical system 120, current status information that characterizes the current energy state of the vehicle electrical system 120 or one or more components associated therewith, such as, for example, the current state of charge associated with one or more batteries onboard the vehicle 100, the current state of health associated with one or more batteries onboard the vehicle 100, the current availability or connectivity state of one or more batteries onboard the vehicle 100 (e.g., whether a high voltage battery is available), and/or the like. Additionally, the power management service 104 may retrieve, from a ECU 132 or other control module associated with a vehicle control system 130, current status information that characterizes the current operating state of the vehicle 100 or one or more components associated therewith, such as, for example, the current operating mode of the vehicle 100 (e.g., standby, ready, drive, park, etc.), the current state of one or more vehicle components (e.g., a current gear state), the current speed, acceleration, heading or other characteristic(s) associated with the vehicle 100, a current occupancy state of the vehicle 100, a current connectivity state or over-the-air (OTA) updating status, and/or the like.

After obtaining the power usage profile and current vehicle status information, the power management service 104 determines whether or not activation of the requested resource 106, 108 is permitted using one or more activation criteria or other logical rules, which may vary depending on the particular resource being requested, the current vehicle operating state, the current energy state, and/or the like. In this regard, it should be appreciated that there are numerous different potential combinations of activation criteria and logical rules that may be employed to dictate the manner in which the power management service 104 permits or denies resource activation requests depending on the particular implementation, and the subject matter described herein is not intended to be limited to any particular implementation.

For example, in exemplary implementations, the power management service 104 first verifies that the requested resource 106, 108 is permitted to be activated in the current vehicle operating mode, and if not, provides corresponding notification to the requesting software entity 114 that the requested resource 106, 108. In one or more implementations, the power management service 104 automatically permits activation of the requested resource 106, 108 when the current vehicle operating mode is in a ready mode, a drive mode or any other mode other than a standby mode or an off mode where the vehicle 100 is not operational.

In one or more exemplary implementations, when the current vehicle operating mode corresponds to the standby mode or the off mode, the power management service 104 verifies whether the current energy state of the vehicle electrical system 120 supports operation of the requested resource 106, 108 with its associated power usage profile before permitting activation. In this regard, based on the expected power and/or energy consumption associated with the power usage profile for the requested resource 106, 108, the power management service 104 verifies the current configuration of the vehicle electrical system 120 and/or the current state of the available energy sources will support the expected power and/or energy consumption. For example, in one or more implementations, the power management service 104 permits operation of the requested resource 106, 108 when a high voltage battery of the vehicle electrical system 120 is activated, enabled or otherwise connected to the voltage grid associated with the requested resource 106, 108 (e.g., the voltage grid that the requested resource 106, 108 is connected to or otherwise operated from). In some implementations, the power management service 104 may also verify or confirm the current state of charge, current state of health, current voltage level, or other electrical characteristic associated with the high voltage battery satisfies corresponding activation criteria before permitting the resource activation, where the activation criteria may be influenced by or a function of the expected power usage profile.

In one or more exemplary implementations, when the current vehicle operating mode corresponds to the standby mode or the off mode and a high voltage battery is unavailable, the power management service 104 verifies whether a low voltage battery or other energy source (or energy storage element) connected to or otherwise associated with the voltage grid of the requested resource 106, 108 is capable of supporting the expected power and/or energy consumption by the requested resource 106, 108 when utilized with the expected power usage profile. In this regard, the power management service 104 may also verify or confirm the current state of charge, current state of health, current voltage level, or other electrical characteristic associated with the low voltage battery satisfies corresponding activation criteria before permitting the resource activation, where the activation criteria may be influenced by or a function of the expected power usage profile. Thus, when the current energy state of the available low voltage battery is adequate for the vehicle electrical system 120 to support operation of the requested resource 106, 108 with the requested power usage profile, the power management service 104 may permit activation of the requested resource 106, 108 even though the vehicle 100 may currently be in a standby or off operating mode and the high voltage battery is unavailable. On the other hand, when the current energy state of the available low voltage battery is not capable of supporting operation of the requested resource 106, 108 with the requested power usage profile, the power management service 104 may deny activation of the requested resource 106, 108. Similarly, if the vehicle electrical system 120 is exhibiting a fault or other anomalous condition, the power management service 104 may deny activation of the requested resource 106, 108.

In some implementations, when the current energy state of the available low voltage battery is not capable of supporting operation of the requested resource 106, 108, the power management service 104 may communicate or otherwise interact with the BCM 122 or other control module associated with the vehicle electrical system 120 to attempt to automatically reconfigure the vehicle electrical system 120 to support the requested operation of the requested resource 106, 108. For example, the power management service 104 may command, signal or otherwise instruct a BCM 122 or other control module to operate, activate or otherwise enable one or more switching elements or other electrical components to enable connectivity between the high voltage battery and a lower voltage grid associated with the requested resource 106, 108, and thereby automatically and autonomously configuring the vehicle electrical system 120 to modify the current energy state and support the requested resource utilization. In such implementations, the power management service 104 may permit activation of the requested resource 106, 108 after receiving confirmation from the BCM 122 or other control module associated with the vehicle electrical system 120 that the high voltage battery has been activated or otherwise enabled.

Still referring to FIG. 2, after determining the current vehicle state permits or otherwise supports activation of the requested resource(s) with the requested or expected power usage profile(s), the resource activation process 200 translates, maps or otherwise converts the abstract resource activation request into one or more corresponding concrete activation requests at 214 before transmitting or otherwise providing activation request(s) to the appropriate destination for activating the requested resource(s) at 216. In this regard, the requesting software entity 114 may identify the requested resource(s) 106, 108 in an abstract form, such as, for example, by a name or other identifier associated with the respective resource 106, 108. In response to determining activation of a requested resource 106, 108 is permitted, the power management service 104 translates, maps or otherwise converts the abstract resource identifier provided by the requesting software entity 114 into a tangible, concrete address, such as, for example, a specific hardware address, physical address, network address and/or the like associated with the respective resource 106, 108 that is capable of receiving a corresponding activation request from the power management service 104. Similarly, after identifying the specific tangible or concrete resource 106, 108 to be activated, the power management service 104 identifies the specific activation messages, commands, instructions or other signals to be transmitted or otherwise provided to that concrete address to activate that resource 106, 108. For example, for local resources 106, the power management service 104 may translate the abstract resource identifier to a corresponding I/O interface 116 that is connected to or otherwise coupled to the respective local resource 106 (or a control module or other controller associated with the local resource 106). The power management service 104 may then transmit or otherwise communicate corresponding activation commands or instructions directly to the requested local resource 106 (or a control module associated therewith) via the identified I/O interface 116.

For remote resources 108 that are not directly under the control of the computing device 102, in exemplary implementations, the power management service 104 translates the abstract resource identifier to a corresponding network address associated with the remote resource 108 (or a control module or other controller associated with the local resource 106) or other network identifier that allows the remote resource 108 (or a control module or other controller associated with the local resource 106) to receive, obtain, or otherwise identify an activation request transmitted from the power management service 104 over a communications network. In one or more implementations, the remote resources 108 are coupled to the computing device 102 over a CAN bus, where the power management service 104 maps the abstract resource identifier to a corresponding CAN partial network that includes or is otherwise associated with the requested remote resource 108. Thereafter, the power management service 104 transmits, communicates or otherwise provides an activation request, command or other instruction that is addressed to the particular CAN partial network to wake up, enable or otherwise activate the requested remote resource 108. In this regard, a control module associated with the requested remote resource 108 may monitor or otherwise listen to the CAN bus for messages or communications that include its assigned partial network, and in response to the activation request directed to its partial network, automatically activates or otherwise enables the requested remote resource 108.

In exemplary implementations, the power management service 104 persists or otherwise maintains the activation requests provided to the requested resource(s) 106, 108 in accordance with the power usage profile associated with the resource request received from the software entity 114. In this regard, when the power usage profile indicates a periodic or other discontinuous utilization of the requested resource 106, 108, the power management service 104 may automatically modulate or vary the assertion of the activation request in accordance with the power usage profile. For example, when the power usage profile indicates that the software entity 114 would like to utilize or otherwise activate a requested resource 106, 108 for one second out of every minute, the power management service 104 may implement a timer or similar feature that supports the power management service 104 asserting and providing the activation request to the requested resource 106, 108 for a duration of one second before automatically removing or deasserting the activation request for the following fifty-nine seconds before reasserting the activation request. In this manner, the power management service 104 may support various different periodic or discontinuous utilization of resources in accordance with the particular power usage profile desired by a particular software entity 114 without being limited to any particular timing, scheme or other constraint. Thus, a developer of a software entity 114 has flexibility to define particular utilization sequences or time segments when particular resources are desired to be utilized, with the power management service 104 assuming responsibility for activating or deactivating the particular resources for the desired time segments or otherwise in accordance with the defined utilization sequence.

Still referring to FIG. 2, after activating the requested resource(s), the resource activation process 200 continues by broadcasting or otherwise publishing the updated activation state of the resource to the requesting software entity at 218. In this regard, in exemplary implementations, after activating a resource 106, 108, the power management service 104 updates the cached activation state information 113 maintained in the data storage element 112 to identify that that resource 106, 108 is currently active. In addition to the activation state, the cached activation state information 113 may also include information identifying one or more of the software entity 114 associated with the activation request that resulted in activation of the respective resource 106, 108, the power usage profile associated with the activation request that resulted in activation of the respective resource 106, 108, and potentially other information that may be utilized by the power management service 104 to track or otherwise manage activation requests and corresponding activation states of the various available resources 106, 108 onboard the vehicle 100. After updating the activation state information 113, the power management service 104 may publish or otherwise notify the requesting software entity 114 of the updated activation state of the requested resources 106, 108. In this regard, in some implementations, the power management service 104 may broadcast or publish updated activation state information for resources 106, 108 for receipt by any software entity 114 subscribed to the power management service 104 for updated activation state information. Thus, in addition to the requesting software entity 114 utilizing the newly activated resource 106, 108, one or more other software entities 114 may attempt to initiate concurrent utilization of the resource 106, 108 or otherwise attempt to retrieve data or information from the activated resource 106, 108.

In exemplary implementations, the loop defined by 210, 212, 214, 216 and 218 may continually repeat to continually evaluate the current vehicle state and dynamically terminate activation of one or more resources when no longer permitted by the current vehicle state. In this regard, over time, if the current energy state associated with the vehicle electrical system 120 and/or the current operating state of the vehicle indicated by the vehicle control system 130 corresponds to a vehicle state in which activation of a particular resource 106, 108 is no longer permitted and/or supported, the power management service 104 may automatically terminate activation of the resource 106, 108 (e.g., by removing or deasserting an activation request, failing to provide an activation request, or the like) and provide corresponding notification to the requesting software entity 114 that previously requested the activation (e.g., at 206). For example, if the vehicle 100 is transitioned into a standby operating mode and the state of charge of a low voltage battery of the vehicle electrical system 120 falls below a resource activation threshold for supporting the requested power usage profile associated with a particular resource 106, 108, the power management service 104 may automatically terminate activation of that particular resource 106, 108 to conserve energy and prolong availability of the low voltage battery.

Referring again to FIG. 1 with reference to FIG. 2, in exemplary implementations, the power management service 104 is also configured to support managed deactivation of previously activated resources by verifying or otherwise confirming that there are no other active requests for that resource before attempting to deactivate the resource. For example, the power management service 104 may utilize the data storage element 112 to maintain a log or record of the different resource activation requests that are currently active in association with the respective software entity 114 that initiated the respective resource activation request. After providing a resource activation request, a software entity 114 may subsequently provide a corresponding request to terminate that preceding resource activation request or otherwise deactivate the resource(s) that were being utilized by the software entity 114 (e.g., in response to a user exiting a software application).

In response to receiving a deactivation request, the power management service 104 verifies or otherwise confirms that there are no activation requests for those resources 106, 108 that are currently active on behalf of another software entity 114. In this regard, when an active resource activation request for a particular resource 106, 108 exists on behalf of another software entity 114, the power management service 104 may update the log or record to remove or otherwise deactivate the resource activation request that a requesting software entity 114 is attempting to terminate while maintaining activation of the resource 106, 108 and maintaining the active resource activation request for that other software entity 114. In this manner, the power management service 104 deconflicts requests and prevents one software entity 114 from interfering with concurrent utilization of a resource 106, 108 by another software entity 114. On the other hand, when no other active resource activation requests for a particular resource 106, 108 exist, in response to a deactivation request, the power management service 104 deasserts, removes or otherwise ceases to provide activation requests to that resource 106, 108, thereby allowing the particular resource 106, 108 to shut down on its own once it is no longer in use.

In one or more implementations, the power management service 104 utilizes priority information assigned to or otherwise associated with the resource activation requests to permit or deny resource activation and terminate resources in accordance with a priority scheme. In this regard, in some implementations, the requesting software entity 114 may provide indicia of a relative priority associated with the requested resource 106, 108 with respect to the features and/or functionality of the requesting software entity 114. For example, a software entity 114 that is a software application that supports navigation or other route planning features may identify a resource activation request for a GPS receiver as a higher priority requests, while another resource activation request from that software entity 114 for a communications systems (e.g., to check for OTA software updates) may be designated as a lower priority request since it has lesser impact on the navigation or other route planning features associated with the software. That said, in other implementations, the power management service 104 may be configured to automatically assign priorities to resource activation requests in accordance with various different prioritization schemes or other criteria (e.g., by assigning priorities highest to lowest in a first in last out manner, etc.) which are not germane to this disclosure, and the subject matter described herein is not intended to be limited to any particular prioritization scheme or prioritization criteria.

During operation, the power management service 104 may utilize the priority information associated with the different resource activation requests to determine whether to permit, deny and/or terminate utilization of a particular resource (e.g., at 212 of the resource activation process 200). For example, depending on the current vehicle state, lower priority resource activation requests may be denied or terminated, for example, to conserve electrical energy or reduce the load on the vehicle electrical system 120, while other higher priority resource activation requests are permitted. In this regard, depending on the implementation, only higher priority activation requests may be permitted in certain vehicle operating modes (e.g., in standby mode) and/or certain energy states (e.g., when the high voltage battery is unavailable, when the state of charge or state of health of the low voltage battery is below a threshold, etc.), while lower priority activation requests are only supported in other vehicle operating modes or energy states where electrical energy conservation or load management is less of a concern (e.g., when the vehicle is in a ready or drive operating mode, when the high voltage battery is available, when the state of charge or state of health of the low voltage battery is above a threshold, etc.). Thus, during operation of the vehicle 100, the power management service 104 and/or the resource activation process 200 may dynamically respond to changes in the current vehicle state by varying the activation and utilization of resources 106, 108 in a corresponding manner to support or otherwise maintain operation of the vehicle 100 and vehicle systems 120, 130 and avoid potentially undesirable impacts by a software entity 114 utilizing vehicle resources 106, 108.

By virtue of the power management service 104 and the resource activation process 200, software entities 114 (e.g., software applications, services, and the like) can be designed independently with resource usage patterns or profiles that do not have to be known or defined when the underlying architecture or platform of a software defined vehicle (SDV) is being designed, in other words, the SDV may be designed independent from the software entities. By abstracting and decoupling the underlying physical, concrete, hardware implementation, the software entities can be developed, defined and deployed in a flexible manner independent of any particular vehicle platform or architecture, with the power management service supporting dynamic and variable resource utilization that may vary depending on the software entities involved in a particular implementation. In this regard, the power management service utilizes the energy state, operating mode, and other vehicle state information to dynamically determine in real-time whether the requested utilization of vehicle resources can be supported, and can proactively take actions to modify the current energy state or configuration of the vehicle electrical system to support the requested utilization. Moreover, the power management service may utilize priorities associated with different resource requests to intelligently manage what resources are activated and/or which software entities are prioritized dynamically in real-time as dictated by the current vehicle state.

While at least one exemplary aspect has been presented in the foregoing detailed description, it should be appreciated that a vast number of variations exist. It should also be appreciated that the exemplary aspect or exemplary aspects are only examples, and are not intended to limit the scope, applicability, or configuration of the disclosure in any way. Rather, the foregoing detailed description will provide those skilled in the art with a convenient road map for implementing the exemplary aspect or exemplary aspects. It should be understood that various changes can be made in the function and arrangement of elements without departing from the scope of the disclosure as set forth in the appended claims and the legal equivalents thereof.

What is claimed is:

1. A method of managing energy consumption in a vehicle, the method comprising:
obtaining, at a power management service executing on a computing device onboard the vehicle, an abstract request for activation of a resource associated with the vehicle from a software entity, the abstract request comprising a usage profile associated with a requested activation of the resource;
obtaining, by the power management service, current status information for the vehicle from one or more systems associated with the vehicle;
determining, by the power management service, the requested activation of the resource is permitted based at least in part on the current status information and the usage profile associated with the abstract request; and
in response to determining the requested activation of the resource is permitted, automatically providing, by the power management service, a concrete activation request to the resource.

2. The method of claim 1, further comprising translating, by the power management service, the abstract request from an abstract form into the concrete activation request by identifying a destination associated with the resource associated with the abstract request and an appropriate format for the concrete activation request prior to providing the concrete activation request in the appropriate format to the destination associated with the resource.

3. The method of claim 1, further comprising mapping, by the power management service, an abstract identification of the resource associated with the abstract request to a concrete address associated with the resource prior to providing the concrete activation request to the concrete address.

4. The method of claim 1, wherein:
obtaining the current status information comprises obtaining a current energy state of an electrical system of the vehicle from a control module associated with the electrical system; and
determining the requested activation of the resource is permitted comprises verifying the current energy state of the electrical system satisfies one or more activation criteria for the resource.

5. The method of claim 4, further comprising the power management service instructing the control module associated with the electrical system to modify a state of the electrical system to support the requested activation of the resource after determining the current energy state of the electrical system does not satisfy the one or more activation criteria.

6. The method of claim 5, wherein instructing the control module associated with the electrical system to modify the current energy state comprises the power management service instructing the control module to modify the state of a high voltage battery associated with the electrical system prior to providing the concrete activation request to the resource.

7. The method of claim 1, wherein:
obtaining the current status information comprises obtaining a current vehicle mode from a control module associated with the vehicle; and
determining the requested activation of the resource is permitted comprises verifying the requested activation of the resource is permitted in the current vehicle mode.

8. The method of claim 1, further comprising updating, by the power management service, an activation state associated with the resource maintained in a data storage element associated with the computing device after providing the concrete activation request to the resource.

9. The method of claim 1, further comprising publishing, by the power management service, an updated activation state associated with the resource to the software entity after providing the concrete activation request to the resource.

10. The method of claim 1, wherein automatically providing the concrete activation request to the resource comprises periodically providing the concrete activation request to the resource in accordance with the usage profile when the usage profile comprises a periodic usage profile.

11. The method of claim 1, wherein automatically providing the concrete activation request to the resource comprises the power management service maintaining the requested activation of the resource in accordance with the usage profile until determining the requested activation of the resource should be terminated.

12. A non-transitory computer-readable medium comprising executable instructions that, when executed by a processor, cause the processor to provide a power management service configurable to:
receive an abstract request for activation of a resource associated with a vehicle from a software entity, the abstract request comprising a usage profile associated with a requested activation of the resource;
obtain, from one or more systems onboard the vehicle, current status information for the vehicle;
determine the requested activation of the resource associated with the abstract request is permitted based at least in part on the current status information and the usage profile associated with the abstract request; and
in response to determining the requested activation of the resource is permitted, automatically provide a concrete activation request to the resource.

13. The non-transitory computer-readable medium of claim 12, wherein the power management service is configurable to translate the abstract request from an abstract form into the concrete activation request prior to providing the concrete activation request to the resource.

14. The non-transitory computer-readable medium of claim 12, wherein the power management service is configurable to map an abstract identification of the resource associated with the abstract request to a concrete address associated with the resource prior to providing the concrete activation request to the concrete address.

15. The non-transitory computer-readable medium of claim 12, wherein the power management service is configurable to obtain a current energy state of an electrical system of the vehicle from a control module associated with the electrical system and verify the current energy state of the electrical system satisfies one or more activation criteria for the resource before determining the requested activation of the resource is permitted.

16. The non-transitory computer-readable medium of claim 15, wherein the power management service is configurable to instruct the control module associated with the electrical system to modify a state of a high voltage battery associated with the electrical system to support the requested activation of the resource after determining the current energy state of the electrical system does not satisfy the one or more activation criteria prior to providing the concrete activation request to the resource.

17. The non-transitory computer-readable medium of claim 12, wherein the power management service is configurable to obtain a current vehicle mode from a control module associated with the vehicle and verifying the requested activation of the resource is permitted in the current vehicle mode prior to determining the requested activation of the resource is permitted.

18. A vehicle comprising:
an electrical system to operate a resource associated with the vehicle, wherein the resource is coupled to the electrical system; and
a computing device coupled to the electrical system and the resource, wherein the computing device includes a non-transitory computer-readable medium comprising executable instructions and a processor coupled to the non-transitory computer-readable medium to execute the executable instructions to provide a power management service that is configurable to:
receive an abstract request for the resource associated with the vehicle from a software entity, the abstract request having a usage profile for a requested activation of the resource associated therewith;
obtain a current energy state of the electrical system from a control module associated with the electrical system;
determine the requested activation of the resource associated with the abstract request is permitted based at least in part on the current energy state and the usage profile associated with the abstract request; and
in response to determining the requested activation of the resource is permitted, automatically provide a concrete activation request to the resource.

19. The vehicle of claim 18, wherein the software entity comprises a software application or a software service configurable to provide the abstract request in an abstract form, wherein the power management service is configurable to translate the abstract request from the abstract form to a concrete form before providing the concrete activation request to the resource.

20. The vehicle of claim 19, wherein the power management service is configurable to map an abstract identification of the resource associated with the abstract request to a concrete address associated with the resource prior to providing the concrete activation request to the concrete address.
